(19) United States
(12) Patent Application Publication
(10) Pub. No.: US 2025/0242946 A1
(43) Pub. Date: Jul. 31, 2025

(54) SYSTEM AND METHOD FOR REPAIRING AIRCRAFT STRUCTURES

(71) Applicant: Airbus Operations S.L.U., GETAFE (ES)

(72) Inventor: Julián GARCÍA SERRANO, GETAFE (ES)

(21) Appl. No.: 19/035,108

(22) Filed: Jan. 23, 2025

(30) Foreign Application Priority Data
Jan. 25, 2024 (EP) 24382065.1

(51) Int. Cl. B64F 5/40

(52) U.S. Cl. CPC B64F 5/40

(57) ABSTRACT

A system for repairing aircraft structures comprises a frame that is divided into two portions, and one or more straps that attach both portions of the frame to each other. A method of repairing includes the step of making a cutout in the skin of the structure to be repaired; dividing the frame into two portions; placing the two portions of the frame on the internal side of the skin through the cutout; and attaching the two portions of the frame to each other by one or more straps.

### CROSS-REFERENCES TO RELATED APPLICATIONS

This application claims the benefit of European Patent Application Number 24382065.1 filed on Jan. 25, 2024, the entire disclosure of which is incorporated herein by way of reference.

### FIELD OF THE INVENTION

The present invention relates to a system and method for repairing aircraft structures, which allows the installation of an internal frame in a structure of an aircraft without internal access.

### BACKGROUND OF THE INVENTION

Aircraft structures are subjected to various external factors such as environmental conditions, operational stresses, and unforeseen events, resulting in the need for periodic maintenance and repair.

Conventional repair methods often involve the application of patches to reinforce or replace damaged sections of the aircraft structure. While these patches effectively restore structural integrity, they unfortunately introduce aerodynamic penalties that can significantly impact the overall performance of the aircraft.

Aircraft designers and operators strive to optimize aerodynamic efficiency to enhance fuel economy, speed, and overall flight performance. The introduction of external patches, however, disrupts the smooth airflow over the aircraft's surface, leading to increased drag, reduced lift, and altered aerodynamic characteristics.

These penalties not only compromise the aircraft's operational efficiency but also pose challenges in meeting stringent regulatory requirements related to fuel efficiency and emissions.

This problem is even greater in structures of an aircraft without internal access.

The need for structural repair must be balanced with the imperative to maintain or even enhance the aerodynamic characteristics of the aircraft. Therefore, there exists a need for a system a method that can effectively repair structural damage while minimizing the associated aerodynamic penalties.

### SUMMARY OF THE INVENTION

Therefore, an objective of the present invention is to provide a system and method for repairing aircraft structures, which allows the installation of an internal frame in a structure of an aircraft without internal access.

The system and method of the invention may solve the above-mentioned disadvantages and has other advantages which will be described below.

The system and method for repairing aircraft structures according to the present invention are described in one or more embodiments described herein.

In particular, the system for repairing aircraft structures comprises a frame that is divided into two portions, and one or more straps that attach both portions of the frame to each other.

This divided frame permits to place the frame in an internal side of the part or skin of the structured to be repaired, so that the placement of the frame does not affect the aerodynamic features of the aircraft structure.

Furthermore, the strap(s) provides continuity to the frame.

According to a preferred embodiment, each portion of the frame is U-shaped.

Furthermore, the system preferably comprises two straps that attach two opposed ends of the U-shaped portions of the frame.

The system can also comprise a skin insert that is attached to the frame and to the one or more straps, and the skin insert is placed in the skin cutout.

Furthermore, the attaching of these repair parts is made with 2 or 3 rows of blind fasteners.

According to a second aspect, the method for repairing aircraft structures comprises the following steps:
cutout the skin of the structure to be repaired;
dividing a frame into two portions;
placing the two portions of the frame on the internal side of the skin through said cutout; and
attaching the two portions of the frame to each other by one or more straps.

The method can also comprise placing a skin insert in the skin cutout and attaching the skin insert to the frames and one or more straps.

Preferably, the attaching of these repair parts is made with 2 or 3 rows of blind fasteners.

### BRIEF DESCRIPTION OF THE DRAWINGS

For a better understanding of what has been explained above, some drawings are included in which, schematically and only by way of a non-limiting example, a practical case of embodiment is represented.

FIG. 1 is a plan inner view of a portion of an aircraft structure in which the system according to the present invention has been applied;

FIG. 2 is a section view along line II-II of FIG. 1; and

FIG. 3 is a section view along line III-III of FIG. 1.

### DETAILED DESCRIPTION OF THE PREFERRED EMBODIMENTS

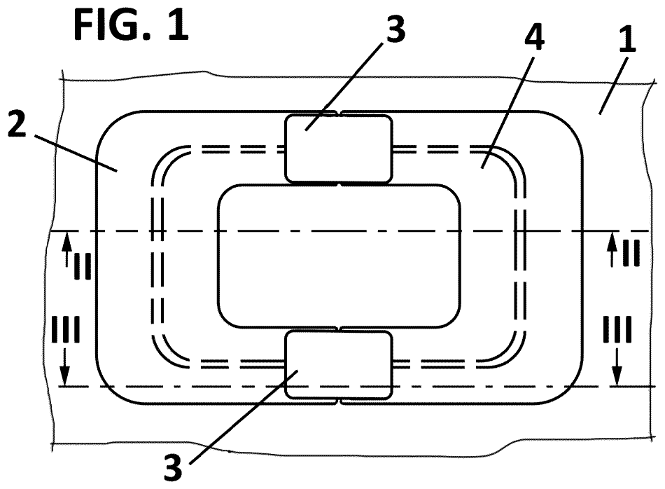

FIG. 1 shows a preferred embodiment of the repair system according to the present invention, that covers a portion to be repaired of a skin 1 of an aircraft structure, said skin 1 defining an internal side and an external side.

The system comprises a frame 2 that is divided into two portions adapted to the contours of the damaged area. The system further comprises one or more straps 3 designed to attach both portions of the frame 2 securely, ensuring a robust structural connection.

According to the shown embodiment, each portion of the frame 2 assumes a U-shaped configuration, providing an optimized geometry for effective repair applications. Additionally, to enhance the structural integrity and stability of the repair, two straps 3 are used to attach the opposed ends of the U-shaped portions.

The repair system also comprises preferably a skin insert 4 that is attached to the frames 2 and to the one or more straps 3. This skin insert 4 is positioned in the skin cutout to contribute additional support and reinforcement.

The connection between the frame 2, the skin insert 4, and the straps 3 is preferably made by blind fasteners 5, e.g., countersunk blind fasteners. These blind fasteners 5 securely and efficiently attach the components together, ensuring a durable repair.

In a preferred arrangement, the blind fasteners 5 are organized in rows, further enhancing the structural stability and uniformity of the repair.

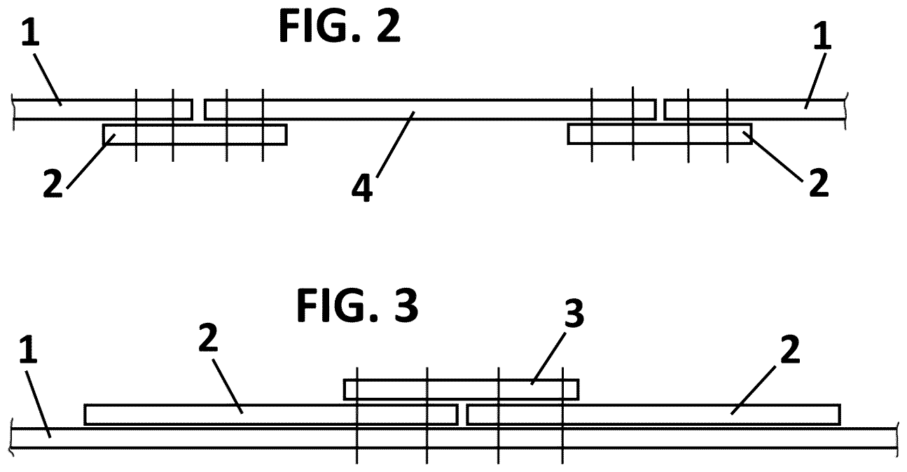

As shown in FIG. 2, the frame 2 is placed internally with respect to the skin 1, and the skin insert 4 is placed aligned with respect to the skin 1.

Furthermore, as shown in FIG. 3, the straps 3 are placed internally with respect to both the frame 2 and the skin 1.

For placing the repairing system in place in the aircraft structure, firstly a cutout is done in the external side of the skin 1.

Subsequently, both portions of the frame 2 are introduced through the cutout onto the internal side of the skin 1. The two portions of the frame 2 are then securely attached to each other by the one or more straps 3.

In the event that additional reinforcement is desired, a skin insert 4 is placed in the skin cutout and the skin insert 4 is attached to the frame and the one or more straps 3.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A system for repairing aircraft structures comprising:
a frame, wherein the frame is divided into two portions, and
one or more straps that attach the two portions of the frame to each other.

2. The system for repairing aircraft structures according to claim 1, wherein each of the two portions of the frame is U-shaped.

3. The system for repairing aircraft structures according to claim 2, wherein the one or more straps comprises two straps that attach two opposed ends of the two portions of the frame.

4. The system for repairing aircraft structures according to claim 1, further comprising:
a skin insert attached to the frame and to the one or more straps.

5. The system for repairing aircraft structures according to claim 4, wherein the skin insert is placed in a skin cutout.

6. The system for repairing aircraft structures according to claim 4, wherein the frame, or the skin insert, or both is attached to the one or more straps by blind fasteners.

7. The system for repairing aircraft structures according to claim 6, wherein the blind fasteners are placed in rows.

8. A method for repairing an aircraft structure, wherein the aircraft structure to be repaired comprises a skin defining an internal side and an external side, wherein the method comprises the following steps:
making a cutout in the skin of the aircraft structure to be repaired;
dividing a frame into two portions;
placing the two portions of the frame on the internal side of the skin through said cutout; and
attaching the two portions of the frame to each other by one or more straps.

9. The method according to claim 8, further comprising:
placing a skin insert in the skin cutout and attaching the skin insert to the frame and one or more straps.

10. The method according to claim 9, wherein the attaching the skin insert to the one or more straps is made with rows of a plurality of blind fasteners.

11. The method according to claim 8, wherein the attaching the two portions of the frame to each other by the one or more straps is made with rows of a plurality of blind fasteners.
